(19) United States
(12) Patent Application Publication
(10) Pub. No.: US 2008/0314193 A1
(43) Pub. Date: Dec. 25, 2008

(54) CRANK ARM ASSEMBLY AND RELATED CRANK ARM AND ELEMENT FOR TRANSMITTING TORQUE FROM THE CRANK ARM TO A BICYCLE CHAIN

(75) Inventor: Mario Meggiolan, Creazzo (Vicenza) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: CAMPAGNOLO S.R.L., Vicenza (IT)

(21) Appl. No.: 12/109,789

(22) Filed: Apr. 25, 2008

(30) Foreign Application Priority Data
Jun. 19, 2007 (IT) MI2007A001221

(51) Int. Cl. B62M 3/00

(52) U.S. Cl. 74/594.1

(57) ABSTRACT

A crank arm assembly for a bicycle, comprising a crank arm and an element for transferring torque from the crank arm to a bicycle chain. The crank arm (and the element for transferring torque respectively comprise first and second front coupling means provided with respective matching profiles adapted to be coupled together to transfer torque from the crank arm to the element for transferring torque. In particular, the first and second means for transferring torque comprise respective front toothings, preferably Hirth toothings.

### FIELD OF INVENTION

The present invention relates to a crank arm assembly for a bicycle. The invention also relates to a crank arm for such an assembly and an element for transmitting torque from the aforementioned crank arm to a bicycle chain.

### BACKGROUND

Right crank arm assemblies are known in which the crown is directly coupled with the right crank arm.

In such assemblies, the right crank arm is made star shaped and comprises a plurality of coupling arms to attach the crank arm to the crown. The crown, in turn, comprises an annular element having, a toothing and, a plurality of elements for coupling with the crank arm. The coupling between crank arm and crown is carried out through a plurality of screws which are inserted into respective holes formed on the respective coupling surfaces of the arms of the crank arm and of the coupling elements of the crown.

One of the drawbacks of an assembly of the type described above is that they require the use of cranks made from metallic material, and thus particularly heavy. Indeed, in such an assembly the transfer of motion from the crank arm to the crown takes place at limited and localized areas (in particular, at the areas in which the screws are provided), a high concentration of tension being generated in such areas. Moreover, the crank arm of such an assembly is particularly massive and bulky, having to provide on the crank arm the spokes for coupling with the crown. The use of metallic cranks, moreover, does not meet the continuous increasing need of bicycle manufacturers, above all racing bicycle manufacturers, to minimize the weight of bicycle components.

Right crank arm assemblies are also known in which the crown is coupled with the right crank arm through the interposition of an adapter disc.

In such assemblies, the transfer of motion from the crank arm to the adapter is made through coupling means that extend, in the crank arm, radially outwards and, in the adapter, radially inwards.

The Applicant observes that in conventional crank arm assemblies providing for the use of an adapter, the provision on the crank arm of coupling means extending radially outwards necessarily requires such coupling means to be made at an annular portion of the crank arm of reduced diameter. Consequently, the overall coupling surface of the crank arm to the adapter is relatively small in size. This causes a high concentration of tension at the coupling between crank arm and adapter, with a consequent risk of breaking the crank arm, especially if it is made from light material.

Accordingly, there remains a need for an improved right crank arm assembly that is particularly light and structurally stronger than those currently known.

### SUMMARY

The invention relates to a crank arm assembly for a bicycle including a crank arm and an element for transferring torque from the crank arm to a bicycle chain. The crank arm and the elements for transferring torque further include a first and second coupling means with matching profiles adapted to be coupled together to transfer torque from the crank arm to the element for transferring torque.

The invention also relates to a crank arm for a bicycle including an elongated body with a first seat for attaching a bicycle pedal, a second seat for coupling with a shaft of a bottom bracket assembly, with an annular portion of the body extending around the second seat.

Further, the invention relates to an element for transferring torque from a crank arm to a bicycle chain including first and second annular elements, a plurality of arms extending between the first annular element and the second annular element, and a means to couple with the crank arm provided by the first annular element.

### BRIEF DESCRIPTION OF THE DRAWINGS

Further characteristics and advantages of the present invention shall become clearer from the following detailed description of some preferred embodiments thereof, made with reference to the attached drawings. In such drawings:

FIG. 1 is an exploded perspective view of a first embodiment of the crank arm assembly of the present invention, wherein the element indicated with reference numeral 3 has been overturned to make some features of the present invention visible;

FIG. 2 is a perspective view of the crank arm of the crank arm assembly of FIG. 1 from a first point of observation;

FIG. 3 is a front view of a portion of the crank arm of the crank arm assembly of FIG. 1 from an opposite point of observation to that of FIG. 2;

FIG. 4 is a view from above of the crank arm of the crank arm assembly of FIG. 1;

FIG. 5 is a longitudinal section of a bottom bracket assembly comprising the crank arm assembly of FIG. 1;

FIG. 6 is a longitudinal section of a second embodiment of the crank arm assembly of the present invention;

FIG. 7 is an exploded perspective view of a third embodiment of the crank arm assembly of the present invention, wherein the element indicated with reference numeral 3 has been overturned to make some features of the present invention visible; and

FIG. 8 is a front view of a portion of a further embodiment of the crank arm of the crank arm assembly of the present invention.

### DETAILED DESCRIPTION OF THE PREFERRED EMBODIMENTS

### Introduction to the Embodiments

Throughout the present description and in the subsequent claims the term “crank arm assembly” is used to indicate an assembly comprising a crank arm and an element adapted to be associated with the crank arm to allow the transfer of motion to the rear wheel of the bicycle, such a motion being imparted by the cyclist on the crank arm through the pedals and being transferred to the rear wheel through the chain coupled with a crown of the crankset of the bicycle.

The present invention relates, in a first aspect thereof, to a crank arm assembly for a bicycle, comprising a crank arm and an element for transferring torque from the crank arm to a bicycle chain, characterized in that the crank arm and the element for transferring torque comprise respective first and second front coupling means provided with respective matching profiles adapted to be coupled together to transfer the torque from the crank arm to the element for transferring torque.

In the context of the invention described here, the aforementioned element for transferring torque can consist of a crown of a bicycle crankset, or an adapter adapted to be operatively arranged between the crank arm and the crown for the attachment of the crank arm to the crown, such an adapter being a distinct element from the crown or made in a single piece with the crown.

Advantageously, the use of front coupling means in the crank arm and in the element for transferring torque to the chain of the bicycle allows the aforementioned coupling means to be made at an annular portion of the crank arm with a diameter larger than what is possible in conventional cranks provided for a radial coupling with the adapter. It is thus possible to provide an overall coupling surface of the crank arm with the element for transferring torque having an extension greater than in the conventional cranks, with greater uniformity of distribution of the load and a consequent reduction of concentration of tension.

Preferably, the first and second front coupling means comprise respective toothings, more preferably Hirth toothings.

Advantageously, the use of matching front toothings on the crank arm and on the element for transferring torque to the chain of the bicycle makes it possible to carry out homogeneous and uniformly distributed torque transmission, with consequent advantages in terms of efficiency of transmission of motion and of structural strength of the assembly. More preferably, the use of Hirth toothings allows, in particular, a high precision of centering in the coupling between crank arm and element for transferring torque, as well as a high efficiency of transmission of motion.

In the preferred embodiment of the crank arm assembly of the present invention, the crank arm comprises an elongated body having, at a first free end portion thereof, a first seat for coupling with a bicycle pedal and, at a second free end portion thereof, a second seat for coupling with a first free end of shaft of a bottom bracket assembly, the aforementioned first coupling means being defined on an annular portion of the aforementioned elongated body extending circumferentially about the second seat.

Preferably, the aforementioned first toothing is defined by a plurality of recesses formed in the elongated body on a surface not projecting cantilevered from the elongated body.

Advantageously, the front coupling means are thus made on the body of the crank arm with no need to provide shanks or portions projecting cantilevered from such a body. The crank arm of the crank arm assembly of the present invention thus has very low axial bulk, making it possible to provide an embodiment of a bottom bracket assembly in which the bearings are housed outside of the housing box of the shaft of such an assembly provided in the frame of the bicycle. Such an embodiment is particularly advantageous and preferred as a result of the bearings being very close to the respective crank arms, the bending torque applied to the shaft through pedaling is of reduced magnitude.

In a first embodiment of the crank arm assembly of the present invention, the first front coupling means extend uniformly over the annular portion of the elongated body of the crank arm.

In an alternative embodiment of the crank arm assembly of the present invention, the first coupling means extend over the annular portion of the elongated body of the crank arm along at least two arcs of circumference of an angular size less than 180°, preferably along three arcs of circumference.

Preferably, as well as through the aforementioned first and second coupling means, the crank arm is coupled with the aforementioned element for transferring torque through a plurality of screws.

In the preferred embodiment of the crank arm assembly of the present invention, the crank arm and the aforementioned element for transferring torque comprise in such a case respectively a plurality of first and second holes for reciprocally coupling through the screws.

Preferably, the first holes are through holes and are formed on the annular portion of the elongated body of crank arm.

In a first embodiment of the crank arm assembly of the present invention, and in particular in the embodiment in which the first coupling means extend along the annular portion of the elongated body of the crank arm for arcs of circumference of an angular size less than 180°, the first holes are formed between two successive arcs of circumference.

In an alternative embodiment, and in particular in the embodiment in which the coupling means of the crank arm extend uniformly along the annular portion of the elongated body of the crank arm, the first holes are integrated into the aforementioned first coupling means.

Irrespective of the specific embodiment of the assembly of the present invention, the provision, at the first coupling means, of holes for coupling through screws with the element for transferring torque allows a particularly stable coupling between crank arm and element for transferring torque to be made, i.e. without undesired relative displacements between crank arm (to which the driving torque is applied through pedaling) and element for transferring torque (subject to a resistant torque applied by the chain through the crown). Moreover, advantageously, since the screws that insert into the aforementioned holes have very low axial bulk, it is possible to make the embodiment of the bottom bracket assembly in which the bearings are housed outside of the housing box provided in the bicycle frame.

In an alternative embodiment of the crank arm assembly of the present invention, at least some of the aforementioned first holes are formed on a portion of the aforementioned elongated body radially inside or outside the annular portion on which the first front coupling means are formed. In a further alternative embodiment of the crank arm assembly of the present invention, the crank arm assembly comprises, instead of the aforementioned screws, a ring nut adapted to operate in abutment onto the element for transferring torque on the opposite side to the second coupling means, such a ring nut being provided with an inner threading for coupling with a threaded end of a shaft of a bottom bracket assembly.

The aforementioned second seat preferably comprises an inner threading, but alternatively it can comprise a grooved inner profile or an inner profile with square faces.

Preferably, the crank arm is made from a light metal alloy or composite material, preferably carbon fiber.

In the case in which the crank arm is made from composite material, the aforementioned first coupling means can be formed on an insert, made from metallic material, incorporated in the crank arm.

Preferably, the aforementioned element for transferring torque comprises a first radially inner annular element, a second radially outer annular element concentric to the first annular element and a plurality of arms extending radially between the first annular element and the second annular element, wherein the second coupling means are defined on the first annular element.

As already stated above, the element for transferring torque can consist of a crown of a bicycle crankset, or an adapter intended to be operatively arranged between the crank arm and the crown of the crankset for transferring torque from the crank arm to the crown. The adapter can be made in a single piece with the crown or be made in a distinct piece from the crown.

In the case in which an adapter is used, the front coupling means are made on the adapter.

Advantageously, the use of an adapter in the coupling between crank arm and crown makes it possible to use cranks that are less bulky and massive than those used in conventional assemblies in which the crank arm is directly coupled with the crown. Moreover, the crank arm, not being arranged to be coupled directly with the crown through screws, can be made from light material. The adapter can also be made from light material, in such a case achieving a substantial reduction in weight of the assembly, for the same structural strength.

In a first embodiment of the crank arm assembly of the present invention, the second coupling means extend uniformly along the first annular element.

In an alternative embodiment of the crank arm assembly of the present invention, the second coupling means extend over the first annular element along at least two arcs of circumference of an angular size less than 180°, preferably along three arcs of circumference.

Preferably, the aforementioned second holes are threaded and are formed on the first annular element, more preferably between two successive arcs of circumference.

Alternatively, the aforementioned second holes can be integrated into the second coupling means.

Alternatively, at least some of the aforementioned holes are formed on a portion of the element for transferring torque radially inside or outside the first annular element.

Preferably, in the case in which an adapter is used, the adapter is made from a light metal alloy or composite material, preferably carbon fiber.

More preferably, in the case in which an adapter made from composite material is used, the aforementioned coupling means can be formed on a metallic insert incorporated in the adapter.

Preferably, the crank arm assembly of the present invention comprises at least one deformation sensor, more preferably a strain gauge, associated with at least one of the arms of the element for transferring torque. Advantageously, such a sensor detects the twisting deformation to which the element for transferring torque is subjected during pedaling. Indeed, during pedaling the radially inner annular element, being coupled with the crank arm, is subjected to the driving torque applied by the cyclist by pedaling whereas the radially outer annular element, being coupled with the chain, is subjected to the resistant torque exerted by the chain. The twisting deformation of the element for transferring torque can provide indications on the structural strength of such an element and on the power imparted by the cyclist, such information being useful both at the design stage of the components of the crank arm assembly of the bicycle and during diagnosis of the behavior of such components during travel.

Preferably, the crank arm assembly of the present invention comprises four deformation sensors, each of which is associated with a respective arm. It is possible in this way to carry out a more uniform and reliable detection of the deformations to which the element for transferring torque is subjected.

Preferably, the sensors are connected as a Wheatstone bridge.

Preferably, the crank arm assembly of the present invention comprises at least one electronic device housed in at least one area defined between two adjacent arms.

The crank arm assembly of the present invention also preferably comprises a pair of covers adapted to couple with the aforementioned element for transferring torque on axially opposite sides at the aforementioned second annular element.

Preferably, at least one of the covers is a solar panel.

In a second aspect thereof, the present invention relates to a crank arm for a bicycle, comprising an elongated body having, at a first free end portion thereof, a first seat for coupling with a bicycle pedal and, at a second free end portion thereof, a second seat for coupling with a first free end of a shaft of a bottom bracket assembly, characterized in that it comprises, at an annular portion of the elongated body extending circumferentially about the second seat, front coupling means.

Advantageously, such a crank arm can be used in an assembly of the type described above.

Preferably, such a crank arm has, individually or in combination, all of the structural and functional characteristics discussed above with reference to the crank arm of the crank arm assembly of the present invention and therefore has all of the aforementioned advantages.

In particular, the front coupling means preferably comprise a toothing, more preferably a Hirth toothing.

Preferably, the toothing is defined by a plurality of recesses formed in the elongated body of the crank arm on a surface not projecting cantilevered from the elongated body.

In a first embodiment of the crank arm of the present invention, the front coupling means extend uniformly along the annular portion of the elongated body of the crank arm.

In an alternative embodiment of the crank arm of the present invention, the coupling means extend over the annular portion of the elongated body of the crank arm along at least two arcs of circumference of an angular size less than 1800, preferably along three arcs of circumference.

Preferably, the crank arm of the present invention comprises a plurality of holes formed on the annular portion of the elongated body of the crank arm.

Preferably, the holes are through holes and more preferably are formed between two successive arcs of circumference.

Alternatively, the aforementioned holes are integrated in the aforementioned second coupling means.

Alternatively, at least some of the aforementioned holes are formed on a portion of the elongated body radially inside or outside the annular portion of the elongated body of the crank arm.

Preferably, the aforementioned second seat comprises an inner threading, but alternatively it can comprise a grooved inner profile or an inner profile with square faces.

Preferably, the elongated body is made from a light metal alloy or composite material, more preferably carbon fiber.

In the case in which the elongated body of the crank arm is made from composite material, the crank arm can comprise an insert made from metallic material in which the aforementioned front coupling means are formed.

In a third aspect thereof, the present invention relates to an element for transferring torque from a crank arm to a bicycle chain, characterized in that it comprises a first radially inner annular element, a second radially outer annular element concentric to the first annular element and a plurality of arms extending radially between the first annular element and the second annular element, front coupling means with the crank arm being defined on the first annular element.

Advantageously, such an element can be used in an assembly of the type described above.

Preferably, such an element has, individually or in combination, all of the structural and functional characteristics discussed above with reference to the element for transferring torque of the crank arm assembly of the present invention and therefore has all of the aforementioned advantages.

In particular, the aforementioned element can consist of a crown of a crankset for a bicycle or, alternatively, an adapter made in a distinct piece from the aforementioned crown and adapted to be operatively arranged between the crank arm and the crown of a crankset for a bicycle, the aforementioned front coupling means being formed in such a case on the adapter.

The coupling means with the crank arm preferably comprise a toothing, more preferably a Hirth toothing.

In a first embodiment of the adapter of the present invention, the coupling means with the crank arm extend uniformly along the first annular element.

In an alternative embodiment of the adapter of the present invention, the coupling means with the crank arm extend over the first annular element along at least two arcs of circumference of an angular size less than 180°, preferably along three arcs of circumference.

Preferably, the element for transferring torque of the present invention comprises a plurality of threaded holes for coupling with the crank arm formed on the first annular element.

Preferably, the holes are formed between two successive arcs of circumference.

Alternatively, they are integrated in the coupling means with the crank arm.

Alternatively, at least some of the holes are formed on a portion of the element radially inside or outside the first annular element.

Preferably, in the case in which an adapter is used, the adapter is made from a light metal alloy or composite material, preferably carbon fiber.

More preferably, in the case in which an adapter made from composite material is used, the aforementioned coupling means can be formed on a metallic insert incorporated in the adapter.

In the preferred embodiment thereof, the element for transferring torque of the present invention comprises a deformation sensor, preferably a strain gauge, associated with at least one of its arms.

More preferably, there are four sensors, each of which is associated with a respective arm.

The sensors are preferably connected as a Wheatstone bridge.

Preferably, the element for transferring torque of the present invention comprises at least one electronic device housed in at least one area defined between two adjacent arms.

The element for transferring torque of the present invention also preferably comprises a pair of covers adapted to couple with the aforementioned element for transferring torque on axially opposite sides at the aforementioned second annular element.

Preferably, at least one of the covers is a solar panel.

In a fourth aspect thereof, the invention relates to a bottom bracket assembly for a bicycle, comprising a crank arm assembly of the type described above.

Preferably, such a bottom bracket assembly has, individually or in combination, all of the structural and functional characteristics discussed above with reference to the crank arm assembly of the present invention and therefore has all of the aforementioned advantages.

In a fifth aspect thereof, the invention relates to a bicycle comprising a crank arm assembly of the type described above.

Preferably, such a bicycle has, individually or in combination, all of the structural and functional characteristics discussed above with reference to the crank arm assembly of the present invention and therefore has all of the aforementioned advantages.

### DETAILED DESCRIPTION

In the figures attached hereto, reference numeral 1 indicates a crank arm assembly in accordance with the present invention. The crank arm assembly 1 is, in particular, a right crank arm assembly and is intended to be used in a bottom bracket assembly of a bicycle, preferably a racing bicycle, to transfer motion from the crank arm to the chain of a bicycle through a crown of a bicycle crankset.

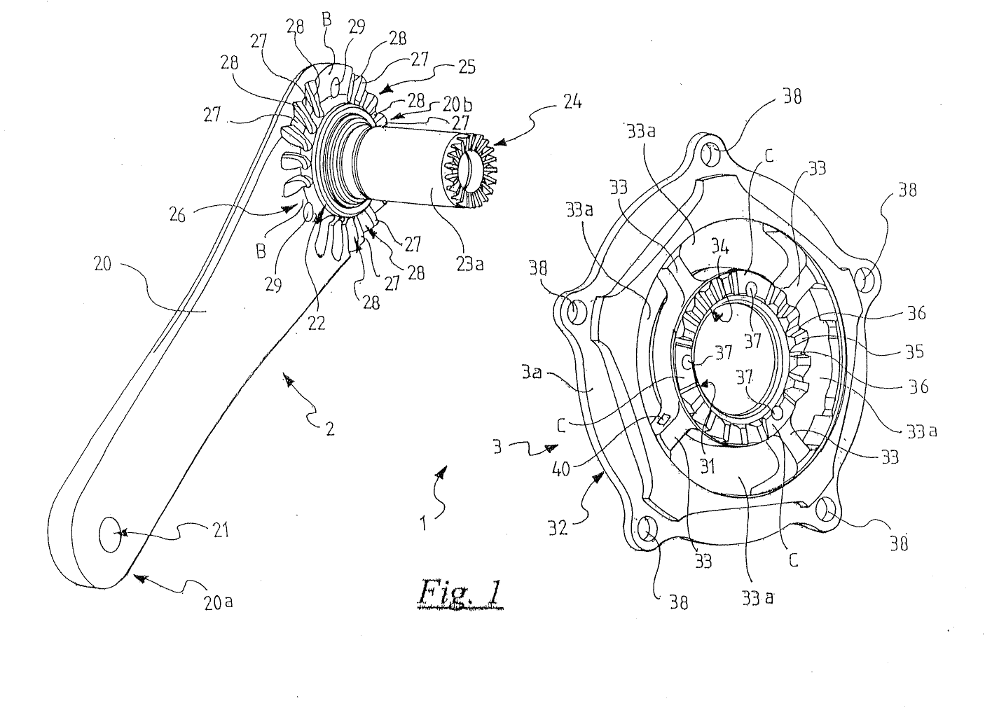

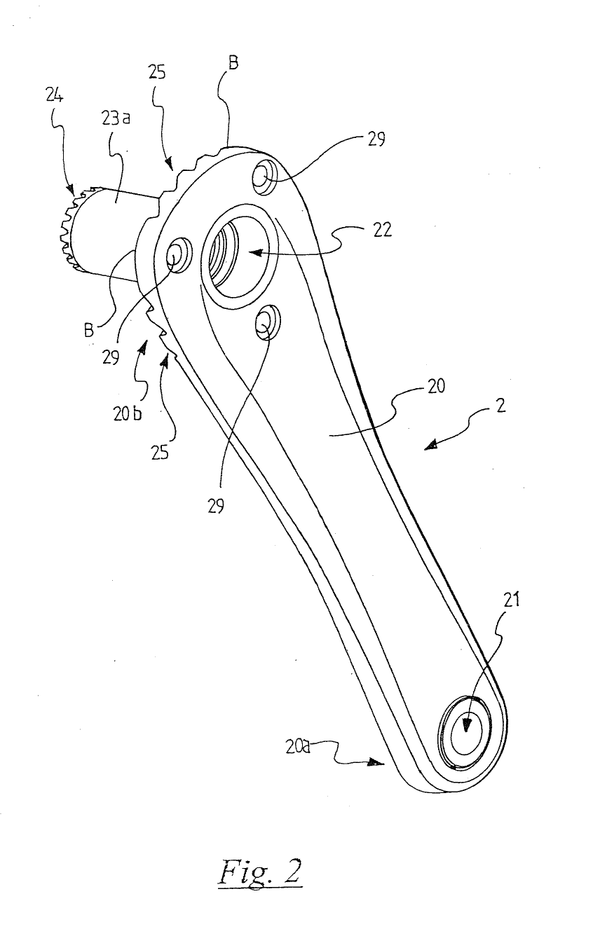

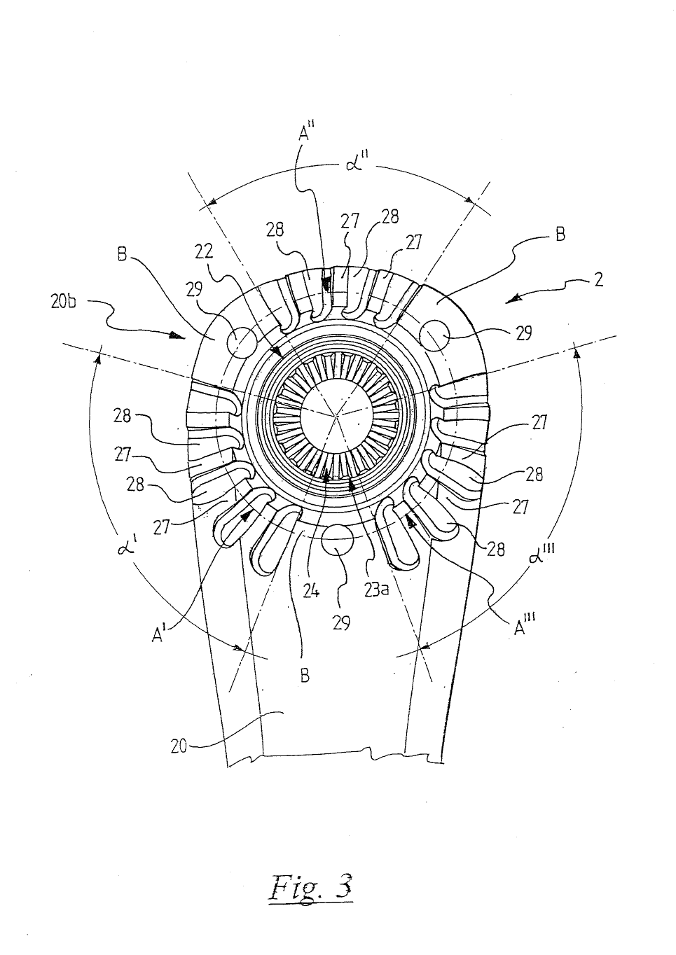

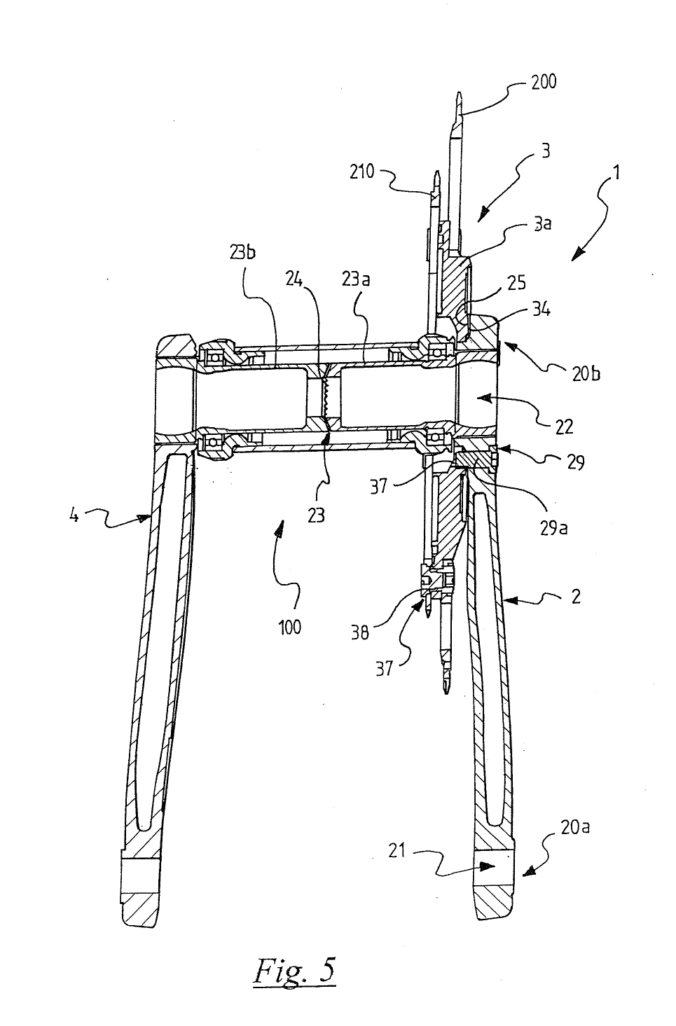

FIG. 1 shows a first embodiment of the crank arm assembly of the present invention. The crank arm of such a crank arm assembly is illustrated in detail in FIGS. 2-4, whereas FIG. 5 illustrates a bottom bracket assembly that uses the crank arm assembly of FIG. 1.

With reference to the aforementioned FIGS. 1-5, the crank arm assembly 1 comprises a crank arm 2, adapted to act as a right crank arm, and an adapter 3a adapted to be coupled with the crank arm 2 and with the crown (indicated with 200 in FIG. 5), so as to allow the transfer of torque from the crank arm 2 to the rear wheel of the bicycle (not illustrated). Such motion is imparted to the crank arm 2 through pedaling and is transferred to the rear wheel through the chain (not illustrated) coupled with the crown 200.

The crank arm 2 comprises an elongated body 20, preferably made from a light metal alloy, like aluminum alloys or other light alloys, or from composite material.

The composite material can in this case comprise structural fibers incorporated in a polymeric material. Typically, the structural fibers are selected from the group consisting of carbon fibers, glass fibers, aramid fibers, ceramic fibers, boron fibers and combinations thereof. Carbon fibers are particularly preferred.

The arrangement of the structural fibers in the polymeric material can be a random arrangement of pieces or sheets of structural fibers, a substantially unidirectional ordered arrangement of fibers, a substantially bi-directional ordered arrangement of fibers or a combination of the above.

Preferably, the polymeric material is thermosetting and preferably comprises an epoxy resin. However, this does not rule out the possibility of using a thermoplastic material.

The elongated body 20 has, at a first free end portion 20a thereof, a first seat 21 for coupling with a bicycle pedal and, at a second free end portion 20b thereof, a second seat 22 for coupling with a shaft 23 of a bottom bracket assembly 100 (see in particular FIG. 2 and FIG. 5).

In the example illustrated in FIGS. 1-5, the second seat 22 is internally threaded and houses a shaft element 23a, provided with an external threading at a free end thereof for coupling with the crank arm 2. However, alternative embodiments are provided in which the crank arm 2 is coupled with the half-shaft 23a through a grooved coupling (in which case the second seat 22 and the free end of the shaft element 23a adapted to be housed in the second seat 22 have respective grooved profiles), or a shape coupling through matching surfaces (for example through respective profiles with square faces). Alternatively, the shaft element 23a can be made in a single piece with the crank arm 2.

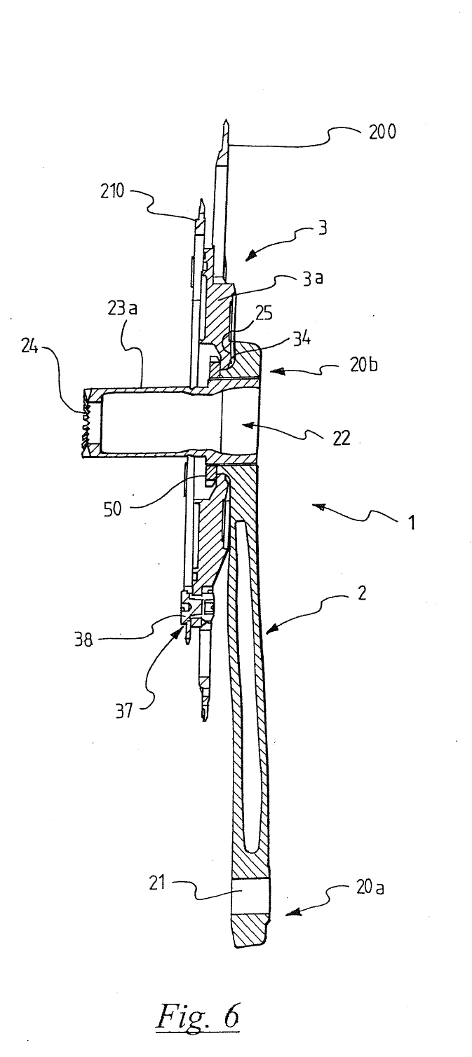

In the present description and the subsequent claim, the term “shaft element” is used to indicate one of the portions of which the shaft of the bottom bracket assembly can consist. The shaft 23 of the bottom bracket assembly in this case is thus made in a distinct piece from the crank arm 2 and consists of at least two shaft elements 23 (in the example illustrated in FIG. 6 the shaft elements 23a and 23b). Alternatively, the shaft 23 of the bottom bracket assembly can be made in a single piece.

The shaft element 23a has, at a free end thereof arranged on the opposite side to the crank arm 2, a shaft front toothing 24, preferably a Hirth toothing, for coupling with the shaft element 23b associated with the other crank arm 4 of the bottom bracket assembly.

The crank arm 2 comprises, at the second free end portion 20b thereof, a front toothing 25, preferably also the Hirth-type. Such a toothing 25, in particular, is formed on an annular portion 26 of the crank arm 2 extending circumferentially about the second seat 22.

The toothing 25 is dug into the elongated body 20 of the crank arm 2. Consequently, the annular portion 26 on which the toothing 25 is formed does not project cantilevered from the remaining portion of the elongated body 20 of the crank arm 2.

The front toothing 25, in particular, is defined by a plurality of teeth 27 identical to one another (only some of which have been numbered in FIGS. 1-4), defined between respective throats 28, which are also identical to one another (only some of which have been numbered in FIGS. 1-4).

The number of teeth 27 is preferably between 2 and 40, more preferably between 10 and 30. In the illustrated example, the number of teeth 27 is equal to 11.

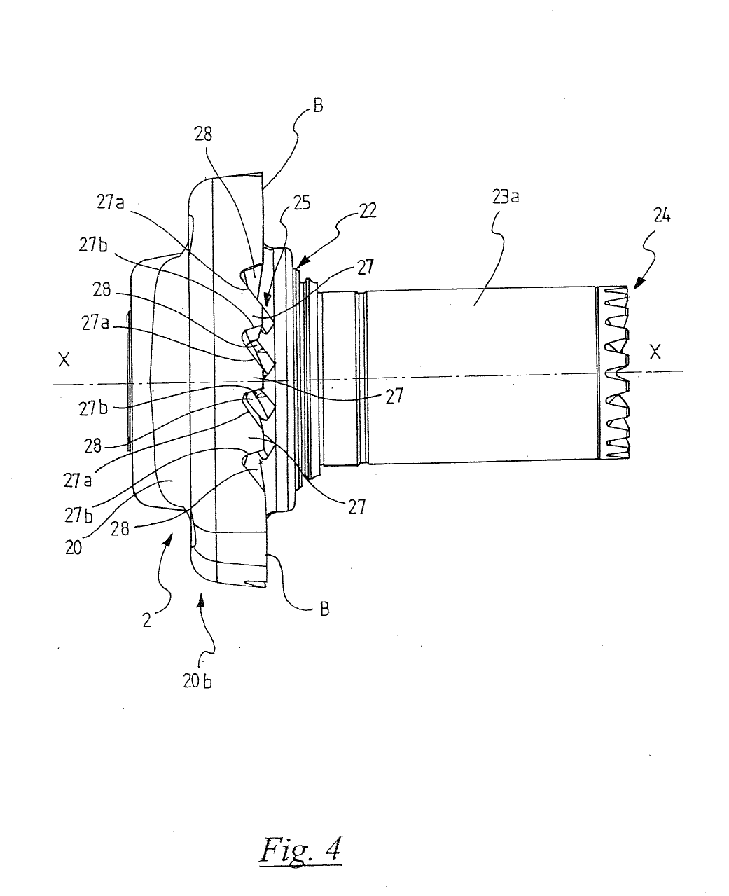

The teeth 27 are asymmetrical with respect to a respective direction parallel to the rotation axis X-X of the crank arm 2. In particular, as illustrated in FIG. 4, the teeth 27 have a side 27a that is more inclined than the opposite side 27b with respect to the aforementioned direction parallel to the axis X-X.

In the embodiment of the crank arm 2 illustrated in FIGS. 1-5, the teeth 27 of the front toothing 25 are distributed over the annular portion 26 of the crank arm 2 along three arcs of circumference A′, A″ and A′″, of an angular size respectively equal to α′, α″ and α′″, areas B without teeth and throats being defined between the aforementioned arcs.

Preferably, the angles α′ and α′″ are the same as one another and are greater than the angle α″. In the illustrated example, at the arcs of circumference A′ and A′″ four teeth 27 are defined between five throats 28, whereas at the arc of circumference A″ three teeth 27 are defined between four throats 28.

Preferably, the angles α′, α″ and α′″are between about 30° and about 120°.

As illustrated in FIGS. 1, 2 and 3, in each of the areas B defined between two successive arcs of circumference A through holes 29 are formed. Such holes 29 are intended to receive screws 29a (one of which can be seen in FIG. 5) to further couple the crank arm 2 with the adapter 3a.

In an embodiment of the crank arm 2 that has not been illustrated, the teeth 27 are distributed over the annular portion 26 of the crank arm 2 uniformly over 360°. In such an embodiment, therefore, the whole annular portion 26 of the crank arm 2 comprises teeth 27 and throats 28 and there are no areas B without teeth 27 and throats 28. In this case, the holes 29 are integrated in the toothing 25, in the sense that they are made directly on the teeth 27 or on the throats 28 of such a toothing or such that a part of the hole 29 is on a tooth and another part of the hole 29 is on a throat 28.

Alternative embodiments of the crank arm 2 are provided in which at least some of the holes 29 can be made on a portion of the elongated body 20 of the crank arm 2 radially inside or outside the annular portion 26 in which the toothing 25 is defined.

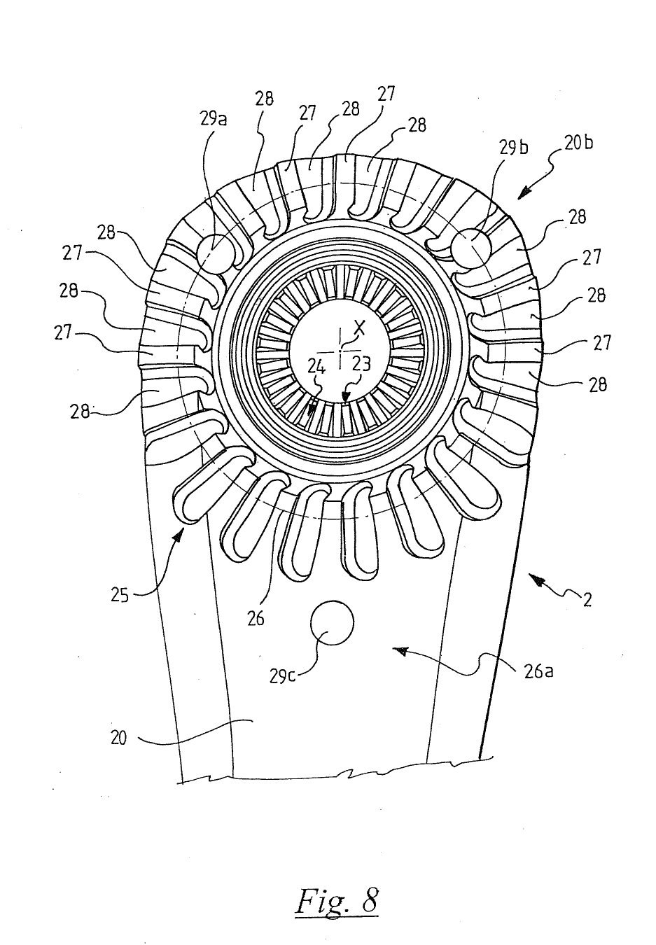

An alternative embodiment of the crank arm is illustrated in FIG. 8. In such a figure, elements corresponding to those described above with reference to FIGS. 1-5 are indicated with the same reference numeral.

The crank arm 2 illustrated in FIG. 8 differs from the one described above and illustrated in FIGS. 1-5 for the sole reason that the teeth 27 are uniformly distributed along the entire annular portion 26 (indicated with a dashed line) and the holes 29a and 29b are made in part on a tooth 27 and in part on a throat 28, whereas the hole 29c is made in a portion 26a of the elongated body 20 of the crank arm 2 radially outside the annular portion 26 on which the toothing 25 is made.

The adapter 3a comprises a first radially inner annular element 31, a second radially outer annular element 32 concentric to the first annular element 31 and a plurality of arms 33 (in the specific example illustrated in FIG. 1, 4 arms) extending radially between the first annular element 31 and the second annular element 32.

On the first annular element 31 a toothing 34, preferably a Hirth toothing, is formed which matches the toothings 25 formed on the crank arm 2. The toothing 34 is indeed adapted to couple with the toothing 25 of the crank arm 2, as illustrated in FIG. 5, to allow the transmission of motion from the crank arm 2 to the crown 200 through the adapter 3a.

The toothing 34 thus comprises teeth 35 Oust one of which is numbered in FIG. 1) and throats 36 Oust two of which are numbered in FIG. 1) totally identical to the teeth 27 and throats 28 of the toothing 25 of the crank arm 2. The arrangement of the teeth 35 and of the throats 36 on the annular element 31 totally mirrors that of the teeth 27 and of the throats 28 on the annular portion 26 of the crank arm 2. In particular, the teeth 35 are distributed over the annular element 31 along three arcs of circumference of an angular size equal, respectively, to the size of the arcs of circumference A′, A″, A′″ defined in the annular portion 26 of the crank arm 2. Moreover, areas C without teeth and throats corresponding to the areas B defined in the annular portion 26 of the crank arm 2 are defined between the aforementioned arcs of circumference defined on the adapter 3a.

As illustrated in FIG. 1, threaded holes 38 are formed in each of the areas C. Such holes 38 are intended to receive the screws 29a passing through the holes 29 of the crank arm 2 (FIG. 5) to further couple crank arm 2 with the adapter 3a.

In an embodiment of the crank arm 2 that has not been illustrated, the teeth 35 are distributed over the annular element 31 uniformly, as described above with reference to an alternative embodiment of the crank arm 2. In such an embodiment, therefore, teeth 35 and throats 36 are distributed over the entire annular element 31 and there are no areas C without teeth 35 and throats 36. In this case, the holes 38 are integrated in the toothing 34, in the sense that they are made directly on a tooth 35 or on a throat 36 of such a toothing.

The adapter 3a is preferably made from metallic material, preferably a light metal alloy, or composite material, preferably carbon fiber, as described above with reference to the crank arm 2.

Preferably, a deformation sensor, more preferably a strain gauge (schematically indicated with 40 in FIG. 1) is associated on at least one of the arms 33 formed on the adapter 3a, so as to be able to detect the twisting deformation to which the adapter 3a is subjected during pedaling.

In the preferred embodiment, there are four strain gauges 40, one for each arm 33 and they are connected according to a Wheatstone bridge scheme.

Electronic devices (not illustrated) for processing the signals detected by the strain gauges 40 are housed in the areas 33a defined between two adjacent arms 33. FIG. 6 shows an alternative embodiment of the crank arm assembly 1 of the present invention. In such a figure, elements corresponding to those described above with reference to FIGS. 1-5 are indicated with the same reference numeral.

The crank arm assembly of FIG. 6 differs from the crank arm assembly 1 of FIGS. 1-5 for the sole reason that on the crank arm 2 and on the adapter 3a holes for reciprocally coupling through screws are not formed. Such reciprocal coupling, as well as through the toothings 25 and 34, is indeed achieved through a ring nut 50 adapted to operate in abutment on the adapter 3a on the opposite side to the toothing 34. For this purpose, the ring nut 50 is provided with an inner threading for coupling with a threaded end of the shaft element 23a inserted into the second seat 22 of the crank arm 2.

FIGS. 5 and 6 also illustrate a second crown 210 with a smaller diameter than that of the first crown 200, also associated with the adapter 3a.

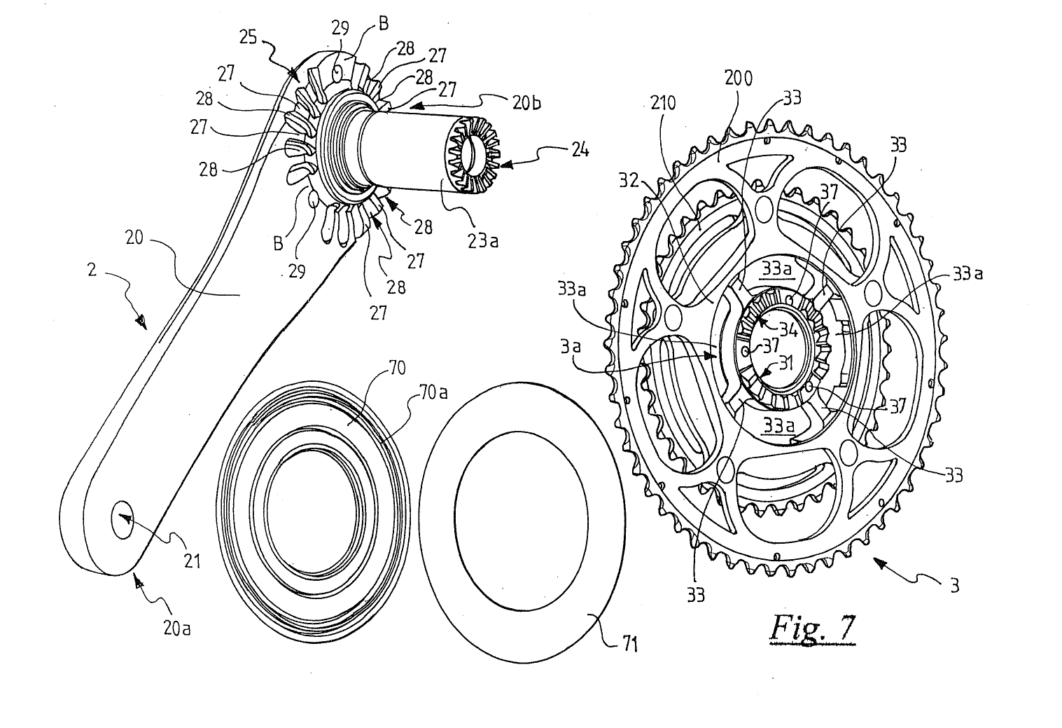

FIG. 7 shows an alternative embodiment of the crank arm assembly 1 of the present invention. In such a figure, elements corresponding to those described above with reference to FIGS. 1-5 are indicated with the same reference numeral.

The crank arm assembly of FIG. 7 differs from the crank arm assembly 1 of FIGS. 1-5 for the sole reason that the adapter 3a here is made in a single piece with the crown 200. In other words, the adapter 3a is defined on a radially inner portion of the crown 200. In this embodiment, therefore, the element 3 that transfers torque from the crank arm 2 to the chain consists of the assembly consisting of the crown 200 and the adapter 3a.

In FIG. 7 two covers 70 and 71 are illustrated adapted to couple with the crown 200 on axially opposite sides at the radially inner portion thereof in which the adapter 3a is defined. The covers 70 and 71 close the spaces 33a in which the aforementioned electronic devices are inserted. At least one of the two covers 70, 71 consists of a solar panel for feeding such electronic devices and sensors 40. The cover 70 is also provided with sealing gaskets 70a.

A further embodiment of the present invention is provided in which the toothing 34 is made directly on the crown 200 and no adapter 3a is used. In this embodiment, therefore, the element 3 that transfers torque from the crank arm 2 to the chain consists of just the crown 200.

In all of the embodiments described above, in the case in which the crank arm 2 and the adapter 3 are made from a composite material, it is possible to provide inserts made from metallic material on which the toothings 25 and 34 are formed.

What is claimed is:

1. Crank arm assembly for a bicycle, comprising a crank arm and an element for transferring torque from the crank arm to a bicycle chain, wherein the crank arm and the element for transferring torque comprise respective first and second front coupling means provided with respective matching profiles adapted to be reciprocally coupled to transfer the torque from the crank arm to the element for transferring torque.

2. Crank arm assembly according to claim 1, wherein the first and second front coupling means comprise respectively a first and a second toothing.

3. Crank arm assembly according to claim 2, wherein the toothings are Hirth-type toothings.

4. Crank arm assembly according to claim 2, wherein the crank arm comprises an elongated body having, at a first free end portion thereof, a first seat for coupling with a bicycle pedal and, at a second free end portion thereof, a second seat for coupling with a first free end of a shaft of a bottom bracket assembly, wherein the first coupling means are defined on an annular portion of the elongated body extending circumferentially about the second seat.

5. Crank arm assembly according to claim 4, wherein the first toothing is defined by a plurality of recesses formed in the elongated body on a surface not projecting cantilevered from the elongated body.

6. Crank arm assembly according to claim 4, wherein the first coupling means extend uniformly along the annular portion of the elongated body.

7. Crank arm assembly according to claim 4, wherein the first coupling means extend over the annular portion of the elongated body along at least two arcs of circumference of an angular size less than 180°.

8. Crank arm assembly according to claim 7, wherein the first coupling means extend over the annular portion of the elongated body along three arcs of circumference.

9. Crank arm assembly according to claim 7, wherein the crank arm and the element for transferring torque respectively comprise a plurality of first and second holes for reciprocally coupling through screws.

10. Crank arm assembly according to claim 9, wherein the first holes are formed on the annular portion of the elongated body.

11. Crank arm assembly according to claim 10, wherein the first holes are through holes.

12. Crank arm assembly according to claim 9, wherein the first holes are formed between two successive arcs of circumference.

13. Crank arm assembly according to claim 9, wherein the first holes are integrated into the first coupling means.

14. Crank arm assembly according to claim 9, wherein at least some of the first holes are formed on a portion of the elongated body which is radially inside or outside the annular portion.

15. Crank arm assembly according to claim 1, comprising a ring nut adapted to operate in abutment onto the torque transferring element on the opposite side to the second coupling means, the ring nut being provided with an inner threading for coupling with a threaded end of a shaft of a bottom bracket assembly.

16. Crank arm assembly according to claim 4, wherein the second seat comprises an inner threading.

17. Crank arm assembly according to claim 4, wherein the second seat comprises a grooved inner profile.

18. Crank arm assembly according to claim 4, wherein the second seat comprises an inner profile with square faces.

19. Crank arm assembly according to claim 1, wherein the crank arm is made from a light metal alloy.

20. Crank arm assembly according to claim 1, wherein the crank arm is made from composite material.

21. Crank arm assembly according to claim 20, wherein the crank arm is made from carbon fiber.

22. Crank arm assembly according to claim 20, wherein the crank arm comprises an insert made from metallic material, the first coupling means being formed in the insert.

23. Crank arm assembly according to claim 9, wherein the element for transferring torque comprises a crown of a bicycle crankset.

24. Crank arm assembly according to claim 23, wherein the element for transferring torque comprises an adapter made in a piece distinct from the crown and operatively arranged between the crank arm and the crown, wherein the second front coupling means are formed on the torque transferring element.

25. Crank arm assembly according to claim 23, wherein the element for transferring torque comprises a first radially inner annular element, a second radially outer annular element concentric to the first annular element and a plurality of arms extending radially between the first annular element and the second annular element, wherein the second coupling means are defined on the first annular element.

26. Crank arm assembly according to claim 25, wherein the second coupling means extend uniformly along the first annular element.

27. Crank arm assembly according to claim 25, wherein the second coupling means extend over the first annular element along at least two arcs of circumference of an angular size less than 180°.

28. Crank arm assembly according to claim 27, wherein the second coupling means extend over the first annular element along three arcs of circumference.

29. Crank arm assembly according to claim 27, wherein the second holes are threaded and are formed on the first annular element.

30. Crank arm assembly according to claim 29, wherein the second holes are formed between two successive arcs of circumference.

31. Crank arm assembly according to claim 29, wherein the second holes are integrated in the second coupling means.

32. Crank arm assembly according to claim 25, wherein at least some of the second holes are formed on a portion of the element for transferring torque which is radially inside or outside the first annular element.

33. Crank arm assembly according to claim 24, wherein the adapter is made from a light metal alloy.

34. Crank arm assembly according to claim 24, wherein the adapter is made from composite material.

35. Crank arm assembly according to claim 34, wherein the adapter is made from carbon fiber.

36. Crank arm assembly according to claim 24, wherein the adapter comprises an insert made from metallic material, the second coupling means being formed in the insert.

37. Crank arm assembly according to claim 25, comprising at least one deformation sensor associated with at least one of the arms.

38. Crank arm assembly according to claim 37, wherein the at least one deformation sensor is a strain gauge.

39. Crank arm assembly according to claim 37, comprising four deformation sensors, each of which is associated with a respective arm.

40. Crank arm assembly according to claim 39, wherein the sensors are connected as a Wheatstone bridge.

41. Crank arm assembly according to claim 37, comprising at least one electronic device housed in at least one area defined between two adjacent arms.

42. Crank arm assembly according to claim 37, comprising a pair of covers adapted to couple with the element for transferring torque on axially opposite sides at the second annular element.

43. Crank arm assembly according to claim 42, wherein at least one of the covers is a solar panel.

44. Crank arm for a bicycle, comprising an elongated body having, at a first free end portion thereof, a first seat for coupling with a bicycle pedal and, at a second free end portion thereof, a second seat for coupling with a first free end of a shaft of a bottom bracket assembly, wherein it comprises, at an annular portion of the elongated body extending circumferentially about the second seat, front coupling means.

45. Crank arm according to claim 44, wherein the front coupling means comprise a toothing.

46. Crank arm according to claim 45, wherein the toothing is a Hirth-type toothing.

47. Crank arm according to claim 45, wherein the toothing is defined by a plurality of recesses formed in the elongated body on a surface not projecting cantilevered from the elongated body.

48. Crank arm according to claim 45, wherein the front coupling means extend uniformly along the annular portion of the elongated body.

49. Crank arm according to claim 45, wherein the coupling means extend over the annular portion of the elongated body along at least two arcs of circumference of an angular size less than 180°.

50. Crank arm according to claim 49, wherein the coupling means extend over the annular portion of the elongated body along three arcs of circumference.

51. Crank arm according to claim 49, comprising a plurality of holes formed on the annular portion of the elongated body.

52. Crank arm according to claim 51, wherein the holes are through holes.

53. Crank arm according to claim 51, wherein the holes are formed between two successive arcs of circumference.

54. Crank arm according to claim 51, wherein the holes are integrated in the coupling means.

55. Crank arm according to claim 51, wherein at least some of the holes are formed on a portion of the elongated body which is radially inside or outside the annular portion.

56. Crank arm according to claim 44, wherein the second seat comprises an inner threading.

57. Crank arm according to claim 44, wherein the second seat comprises a grooved inner profile.

58. Crank arm according to claim 44, wherein the second seat comprises an inner profile with square faces.

59. Crank arm according to claim 44, wherein the elongated body is made from a light metal alloy.

60. Crank arm according to claim 44, wherein the elongated body is made from composite material.

61. Crank arm according to claim 60, wherein the elongated body is made from carbon fiber.

62. Crank arm according to claim 60, wherein the elongated body comprises an insert made from metallic material, the first coupling means being formed in the insert.

63. Element for transferring torque from a crank arm to a bicycle chain, wherein it comprises a first radially inner annular element, a second radially outer annular element concentric to the first annular element and a plurality of arms extending radially between the first annular element and the second annular element, front coupling means with the crank arm being defined on the first annular element.

64. Element according to claim 63, comprising a crown of a bicycle crankset.

65. Element according to claim 64, comprising an adapter made in a piece distinct from the crown and adapted to be operatively arranged between the crank arm and a crown of a bicycle crankset, wherein the front coupling means are formed on the adapter.

66. Element according to claim 63, wherein the front coupling means comprise a toothing.

67. Element according to claim 66, wherein the toothing is a Hirth-type toothing.

68. Element according to claim 63, wherein the front coupling means extend uniformly along the first annular element.

69. Element according to claim 63, wherein the front coupling means extend over the first annular element along at least two arcs of circumference of an angular size less than 180°.

70. Element according to claim 69, wherein the front coupling means extend over the first annular element along three arcs of circumference.

71. Element according to claim 69, comprising a plurality of threaded holes for coupling with the crank arm, the holes being formed on the first annular element.

72. Element according to claim 71, wherein the holes are formed between two successive arcs of circumference.

73. Element according to claim 71, wherein the holes are integrated in the front coupling means.

74. Element according to claim 71, wherein at least some of the holes are formed on a portion of the element which is radially inside or outside the first annular element.

75. Element according to claim 65, wherein the adapter is made from a light metal alloy.

76. Element according to claim 65, wherein the adapter is made from composite material.

77. Element according to claim 76, wherein the adapter is made from carbon fibre.

78. Element according to claim 76, wherein the adapter comprises an insert made from metallic material, the coupling means being formed in the insert.

79. Element according to claim 63, comprising at least one deformation sensor associated with at least one of the arms.

80. Element according to claim 79, wherein the at least one deformation sensor is a strain gauge.

81. Element according to claim 79, comprising four deformation sensors, each of which is associated with a respective arm.

82. Element according to claim 81, wherein the sensors are connected as a Wheatstone bridge.

83. Element according to claims 63, comprising at least one electronic device housed in at least one area defined between two adjacent arms.

84. Element according to claim 63, comprising a pair of covers adapted to couple with the element for transferring torque on axially opposite sides at the second annular element.

85. Element according to claim 84, wherein at least one of the covers is a solar panel.

86. Bottom bracket assembly for a bicycle, comprising a crank arm assembly according to claim 1.

87. Bicycle comprising a crank arm assembly according to claim 1.

88. Crank arm assembly for a bicycle, comprising:
a crank arm comprising an elongated body having, at a first free end portion thereof, a first seat for coupling with a bicycle pedal and, at a second free end portion thereof, a second seat for coupling with a first free end of a shaft of a bottom bracket assembly;
an element for transferring torque from the crank arm to a bicycle chain;
the crank arm and the element for transferring torque include respectively a first and a second toothing with respective matching profiles adapted to be reciprocally coupled to transfer the torque from the crank arm to the element for transferring torque;
wherein the first toothing is defined by a plurality of recesses formed in the elongated body on an annular portion extending circumferentially about the second seat, not projecting cantilevered from the elongated body.

89. Crank arm assembly according to claim 88, wherein the toothings are Hirth-type toothings.

90. Crank arm assembly according to claim 88, wherein the first coupling means extends uniformly along the annular portion of the elongated body.

91. Crank arm assembly according to claim 88, wherein the first coupling means extend over the annular portion of the elongated body along at least two arcs of circumference of an angular size less than 180°.

92. Crank arm assembly according to claim 91, wherein the first coupling means extend over the annular portion of the elongated body along three arcs of circumference.

93. Crank arm assembly for a bicycle, comprising:
a crank arm and an element for transferring torque from the crank arm to a bicycle chain comprising respective first and second front coupling means provided with respective matching profiles adapted to be reciprocally coupled to transfer the torque from the crank arm to the element for transferring torque wherein,
the crank arm and the element for transferring torque respectively comprise a plurality of first and second holes for reciprocally coupling through screws.

94. Crank arm assembly for a bicycle, comprising:
a crank arm, a crown, and an adapter for transferring torque from the crank arm to a bicycle chain,
the crank arm and the adapter for transferring torque comprise respective first and second front coupling means provided with matching profiles adapted to be reciprocally coupled to transfer the torque from the crank arm to the crown,
wherein the adapter is made in a piece distinct from the crown and operatively arranged between the crank arm and the crown.
